(19) United States
(12) Patent Application Publication
(10) Pub. No.: US 2012/0314420 A1
(43) Pub. Date: Dec. 13, 2012

(54) LIGHTING APPARATUS

(76) Inventors: Shoji Yamamoto, Osaka-shi (JP); Hideyuki Akao, Osaka-shi (JP)

(21) Appl. No.: 13/578,771

(22) PCT Filed: Feb. 18, 2011
(86) PCT No.: PCT/JP2011/053474

§ 371 Date: Aug. 13, 2012

(30) Foreign Application Priority Data
Feb. 25, 2010 (JP) 2010-040590

(51) Int. Cl. F21V 3/00; F21V 29/00

(52) U.S. Cl. 362/294; 362/311.14

(57) ABSTRACT

A lighting apparatus includes a light source module, a heat sink holding the light source module and a light-permeable cover mounted to the heat sink and covering the light source module. The cover is adhered to the heat sink by an adhesive agent applied with a gap formed on at least one part between the cover and the heat sink. The inside and outside of the lighting apparatus can be communicated to each other due to the gap. Since the inside and outside of the lighting apparatus are communicated to each other, the problems of temperature difference and pressure difference between inside and outside of the lighting apparatus can be suppressed so that the occurrence of defects because of condensation and the like can be prevented.

### TECHNICAL FIELD

The present invention relating to a lighting apparatus includes a light source, a holder which holds the light source and a light-permeable cover which is mounted to the holder and covers the light source.

### BACKGROUND ART

A lighting apparatus generally includes a light source, a holder holding the light source and a light-permeable cover mounted to the holder and covering the light source. The lighting apparatus is constructed such that the light source is housed in an armoring body having both the holder and cover. With regard to a light-bulb type lighting apparatus such as an incandescent light bulb, it is proposed that the opening edge of a cover such as globe is fixed to the holder by a coating of adhesive agent and then the interior of the lighting apparatus is hermetically sealed (for example, see Patent Document 1).

The lighting apparatus disclosed in Patent Document 1 includes a light source module 201, a light penetrating section 204 that covers the light source module 201, a heat radiating section 202 that radiates the heat generated from the light source module 201, a driving circuit section 203 that drives the light source module 201, a base section 205 that electrically connects to the driving circuit section 203 and connects to an external power source, and an insulating section 206 arranged between the base section 205 and the heat radiating section 202 (see FIG. 1). With regard to this lighting apparatus, an edge of the light penetrating section 204 is adhered to a radiator plate 221 of the heat radiating section 202 such that the edge is in contact with a flange part 224 of the radiator plate 221. As a heat radiating section holding tube 261 of the insulating section 206 is inserted and fixed with a fixing tube 223 of the heat radiating section 202, and as a base holding tube 264 at the opposite side with respect to a coupler section 263 of the heat radiating section holding tube 261 of the insulating section 206 is inserted and fixed with the base section 205, the interior of the lighting apparatus is hermetically sealed.

### PRIOR TECHNICAL DOCUMENT

### Patent Document

[Patent Document 1] Japanese Patent Application Laid-Open No. 2009-4130

### SUMMARY OF THE INVENTION

### Problems to be Solved by the Invention

As refer to the lighting apparatus related to Patent Document 1, when the interior of the lighting apparatus is hermetically sealed, the condensation occurs as the air, which is enclosed inside the lighting apparatus during the manufacturing, cools down, and the pressure inside the lighting apparatus increases when the inner temperature is increased by lighting. Unfortunately, the problem affects the esthetics and durability of the product due to condensation and the like.

In view of such circumstances, the present invention aims to provide a lighting apparatus that can prevent the occurrence of defects due to condensation and the like.

### Means for Solving Problems

A lighting apparatus related to the present invention includes a light source, a holder holding the light source, a light-permeable cover mounted to the holder and covering the light source. The cover is adhered to the holder by an adhesive agent applied with a gap formed on at least one part between the cover and the holder.

In the present invention, by applying the adhesive agent with the gap formed on at least one part between the light-permeable cover, which covers the light source, and the holder holding the light source, the cover is adhered to the holder, therefore, it is possible that inside and outside of the lighting apparatus are communicated to each other through the gap. Since the temperature difference and the pressure difference between the internal air and external air of the lighting apparatus can be suppressed due to the communication between inside and outside of the lighting apparatus, the occurrence of defects due to condensation and the like can be prevented.

With regard to the lighting apparatus related to the present invention, a groove to which an end portion of the cover is freely fitted is provided on the holder, and the adhesive agent is applied with a gap formed on at least one part between the groove and the end portion of the cover.

In the present invention, the groove to which the end portion of the cover is freely fitted is provided on the holder, and the adhesive agent is applied with the gap formed on at least one part between the groove and the end portion of the cover, therefore, the gap is created according to the thickness of the applied adhesive agent between the end portion of the cover and the holder. Since the thickness and range of the applied adhesive agent are appropriately determined, the cross sectional area of the opening of the communication, which is communicated between inside and outside of the lighting apparatus, can be ensured. In other words, since the cross sectional area of air circulation can be ensured, the temperature difference and the pressure difference between the internal air and external air of the lighting apparatus can further be suppressed so that the occurrence of defects due to condensation and the like can be more firmly prevented.

With regard to the lighting apparatus related to the present invention, a slit communicating between inside and outside of the lighting apparatus is provided at a sidewall of the groove.

In the present invention, since the slit communicating between inside and outside of the lighting apparatus is provided at the sidewall of the groove, the internal air and external air of the lighting apparatus can be easily circulated so as to suppress the temperature difference and the pressure difference, therefore, the occurrence of defects due to condensation and the like can be more firmly prevented.

### Effect of the Invention

The present invention can prevent the occurrence of defects due to condensation and the like.

### BRIEF DESCRIPTION OF THE DRAWINGS

FIG. 1 is a schematic longitudinal cross sectional view of a lighting apparatus related to the prior art.

FIG. 2 is a schematic outline view of a lighting apparatus related to the embodiment of the present invention.

FIG. 3 is a schematic exploded perspective view of the lighting apparatus related to the present embodiment.

FIG. 4 is a schematic longitudinal cross sectional view of the lighting apparatus related to the present embodiment.

FIG. 5 is a schematic plan view of a heat sink of the lighting apparatus related to the present embodiment.

FIG. 6 is a schematic cross sectional view of the VI-VI line in FIG. 5.

FIG. 7 is a schematic cross sectional view of a covering of the lighting apparatus related to the present embodiment.

FIG. 8 is a schematic cross sectional view of a cover of the lighting apparatus related to the present embodiment.

FIG. 9A is a schematic local enlarged cross sectional view of an essential part of the lighting apparatus related to the present embodiment.

FIG. 9B is a schematic local enlarged cross sectional view of an essential part of the lighting apparatus related to the present embodiment.

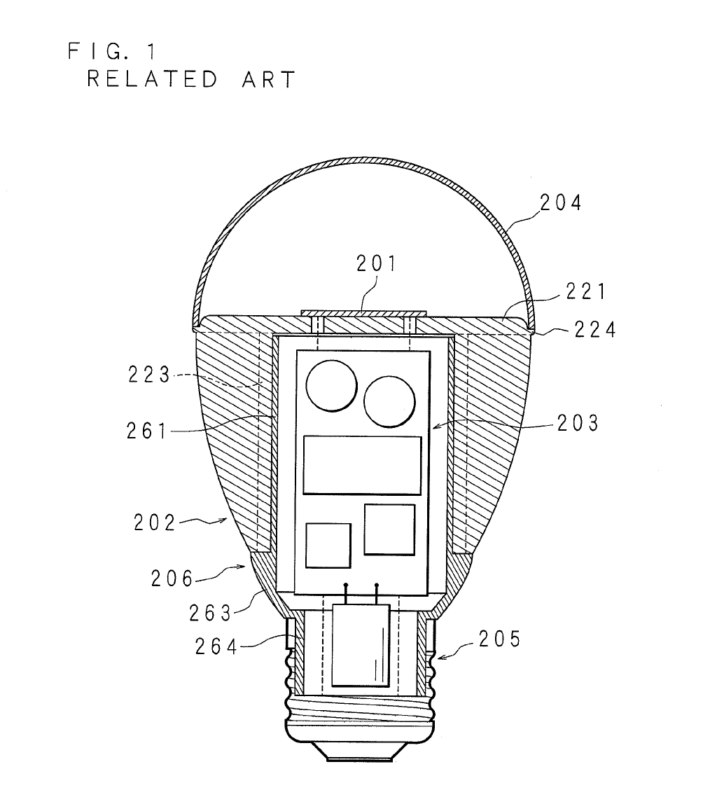

### MODE FOR CARRYING OUT THE INVENTION

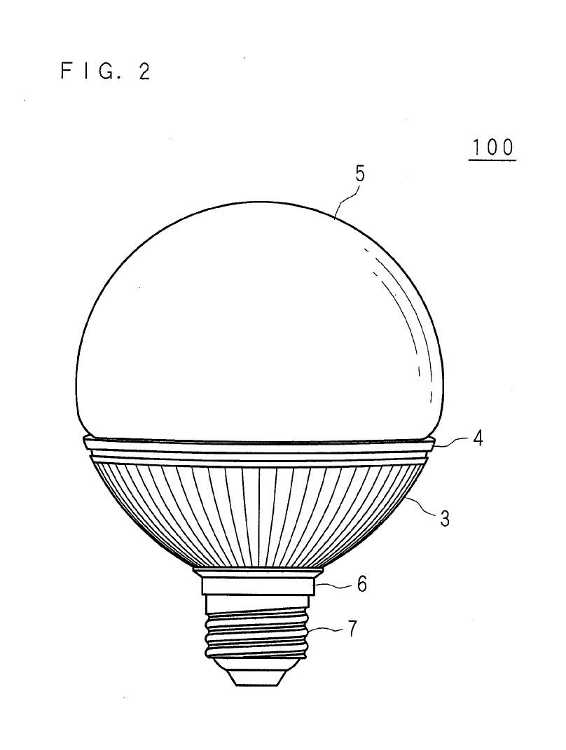

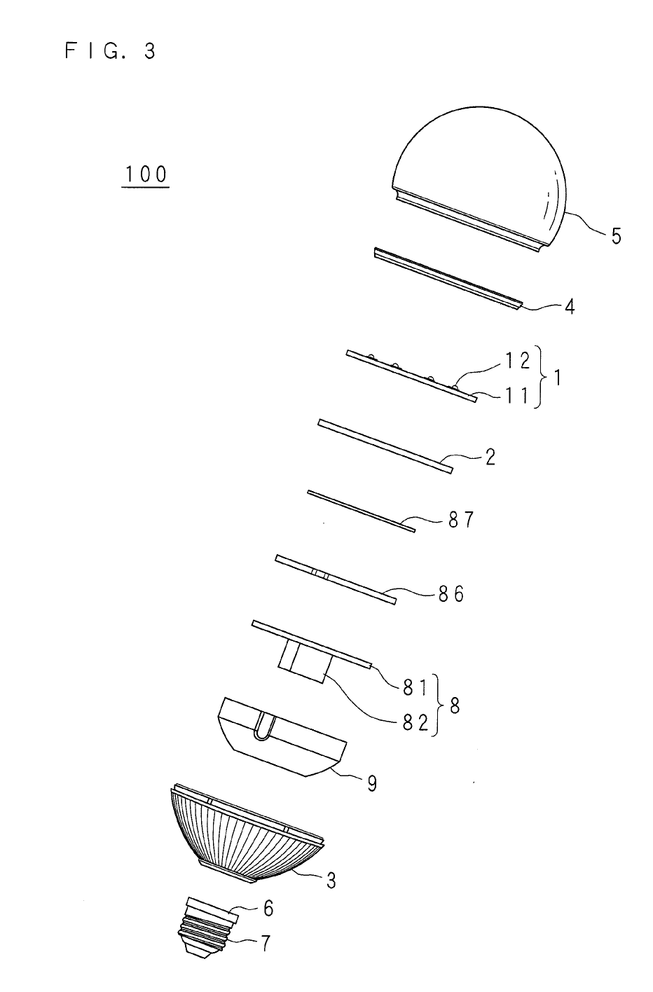

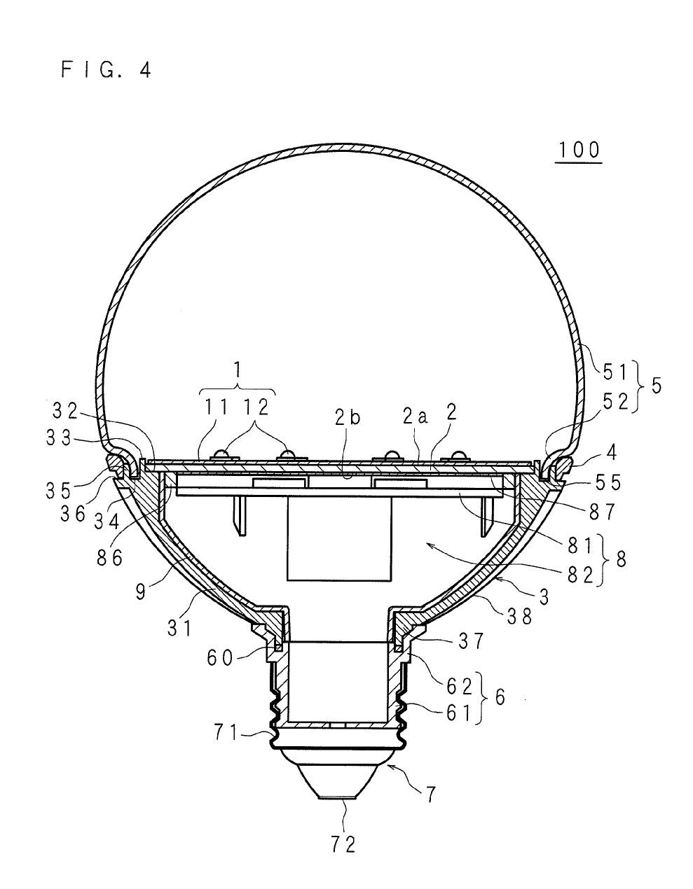

The present invention is described in more detail hereinafter with an example of a so-called ball-lamp type lighting apparatus having an outline shape of a sphere based on the figures showing the embodiment of the present invention. FIG. 2 is a schematic outline view of a lighting apparatus 100 related to the embodiment of the present invention. FIG. 3 is a schematic exploded perspective view of the lighting apparatus 100 related to the present embodiment. FIG. 4 is a schematic longitudinal cross sectional view of the lighting apparatus 100.

In these drawings, a light source module 1 is referred as a light source. The light source module 1 includes a disc-form LED substrate 11 and a plurality of LEDs 12 mounted on one surface of the LED substrate 11. The LED substrate 11 also functions as a thermal conductor conducting the heat from the LED 12 to a heat exchanger plate 2 to which the light source module 1 is attached. The LED substrate 11 is made of metal such as iron, aluminum and the like. The LED 12 is a surface-mount type LED including, for example, an LED element, a sealing resin sealing the LED element, an input terminal and an output terminal.

The LED substrate 11 on which the LED 12 is mounted is fixed to the heat exchanger plate 2 at the other surface which is a surface at non-mounting side. The disc-shaped heat exchanger plate 2 is made of metal such as aluminum and the like. The LED substrate 11 is fixed to one surface 2a of the heat exchanger plate 2.

The heat exchanger plate 2, to which the light source module 1 is attached, is attached to a heat sink 3 as a holder holding the light source at the other surface 2b. Additionally, it is preferable that a thermal conducting sheet or grease with better thermal conductivity is interposed between the LED substrate 11 and the heat exchanger plate 2 as well as between the heat exchanger plate 2 and the heat sink 3. In the present embodiment, the heat exchanger plate 2 is interposed between the light source module 1 and the heat sink 3, however, the heat exchanger plate 2 may be omitted.

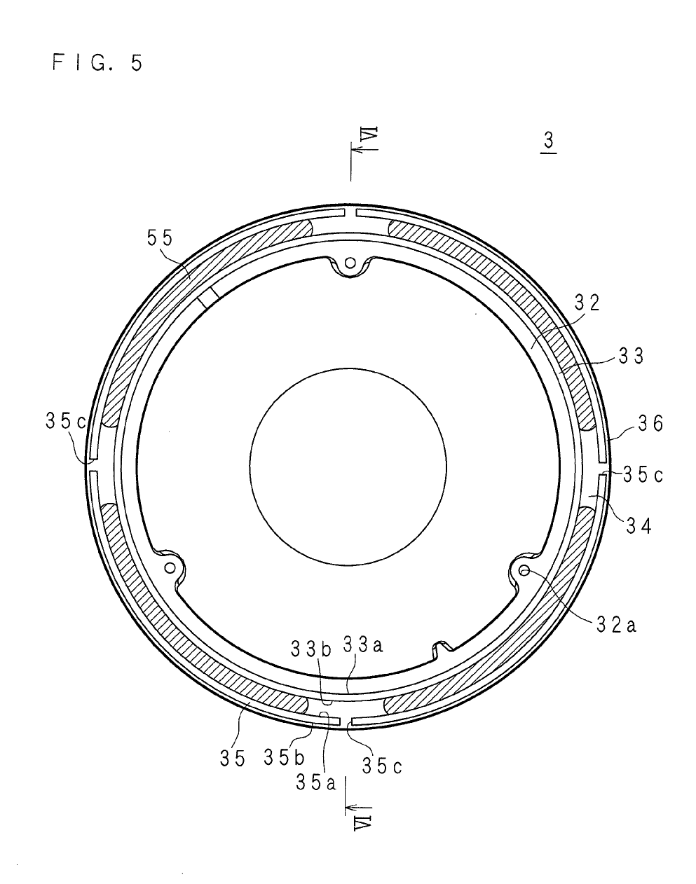

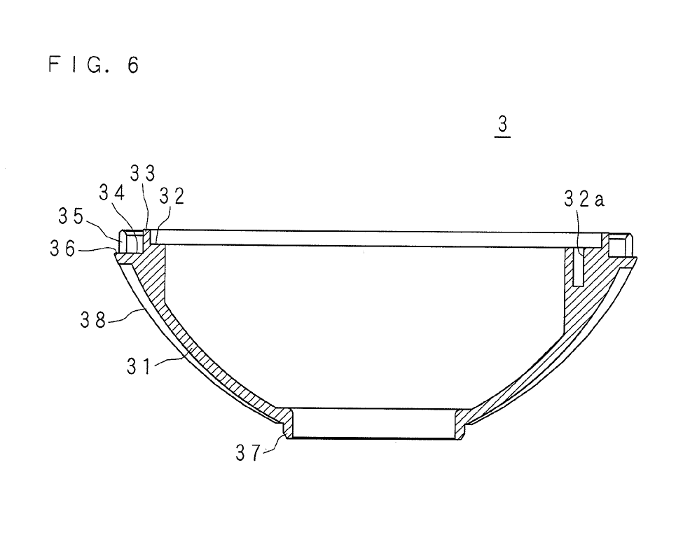

FIG. 5 is a schematic plan view of the heat sink 3 of the lighting apparatus 100 related to the present embodiment. FIG. 6 is a schematic cross sectional view of the VI-VI line in FIG. 5. The heat sink 3 is made of metal, such as aluminum and the like, having lightness in weight and high thermal conductivity and has a tube 31 of which the diameter decreases from one end to the other end. As shown in both FIGS. 4 and 6, the tube 31 forms as a part of spherical shell, more specifically, as a partial hemispherical shell obtained by cutting a spherical shell at two parallel planes.

A flange part 36 is provided around the periphery of one end side of the tube 31. A flat tubular inner peripheral wall 33 and a flat tubular outer peripheral wall 35 are arranged vertically in concentric state at the flange part 36 of the heat sink 3, and a ring-shaped groove 34 is provided such that the inner peripheral wall 33 and the outer peripheral wall 35 are sidewalls of the groove 34. Additionally, with regard to the groove 34, the groove width as a distance between an outer circumferential surface 33b of the inner peripheral wall 33 and an inner circumferential surface 35a of the outer peripheral wall 35 is larger than the thickness of an end portion of the after-mentioned light-permeable cover covering the light source. Therefore, the end portion of the light-permeable cover can be freely fitted into the groove 34. At the outer peripheral wall 35 as one of sidewalls of the groove 34, four rectangular slits 35c are provided with same intervals in the circumferential direction. The slit 35c forms a part of a communication opening communicating between inside and outside of the lighting apparatus 100. In view of the present embodiment, the length of the slit 35c is substantially equal to the height of the outer peripheral wall 35.

Additionally, an attaching portion 32 is provided at one end side of the tube 31. The attaching portion 32 has a circular mounting surface to which the heat radiator plate 2 is attached. The attaching portion 32 is protruded in inward radial direction from the inner circumferential surface of the inner peripheral wall 33. At the inner side of the attaching portion 32, a plurality of boss sections having threaded holes 32a are provided separately with appropriate distance in the circumferential direction. The heat exchanger 2 is attached to the heat sink 3 by fixing with screw in the state that the heat exchanger plate 2 is mounted on the attaching portion 32 in such a manner that the side of the other surface 2b of the heat exchanger plate 2 coincides with the side of the attaching portion 32 of the heat sink 3 and the threaded holes (not shown) provided at the LED substrate 11 and the heat exchanger plate 2 conform with the threaded holes 32a of the attaching portion 32 Therefore, the LED substrate 11 on which the LED 12 is mounted is fixed to the heat sink 3 through the heat exchanger plate 2.

On the other hand, a cylindrical coupler 37 to be coupled to an after-mentioned connecting body is provided at the other end side of the tube 31. Additionally, a plurality of fins 38, which are protruded in outward radial direction across the entire length of the tube 31, are distributed equally in the circumferential direction on the outer circumferential surface of the tube 31. One end of the plurality of fins 38 is connected to the flange part 36 of the heat sink 3.

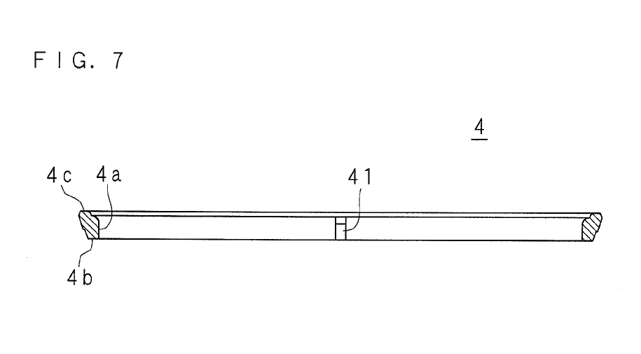

A covering 4 is attached to the flange part 36 of the heat sink 3. FIG. 7 is a schematic cross sectional view of the covering 4 of the lighting apparatus 100 related to the present embodiment. The ring-shaped covering 4 is, for example, made of resin. The diameter of the inner circumferential surface 4a of the covering 4 is formed to be slightly longer than that of the outer circumferential surface 35b of the outer peripheral wall 35, which is vertically arranged on the flange part 36 of the heat sink 3. Four protrusions 41, which are freely fitted to the slits 35c provided at the outer peripheral wall 35 as one of sidewalls of the groove 34, are provided with same intervals in the circumferential direction at the inner circumferential surface 4a of the covering 4. The covering 4 is attached to the flange part 36 of the heat sink 3 in the state that the covering 4 is positioned by freely fitting the protrusions 41 to the slits 35c in such a manner that a side of one side surface 4b coincides with a side of the flange part 36. Additionally, the other side surface 4c of the covering 4 is appropriately formed corresponding to the shape of the cover as stated below.

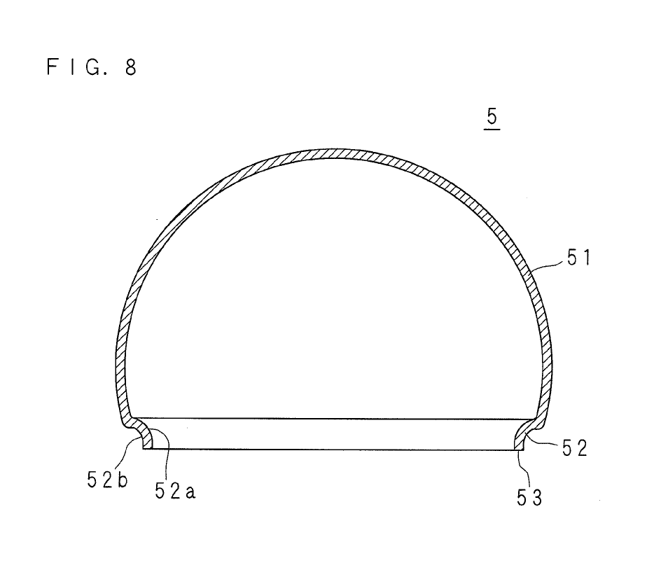

The light-permeable cover 5, which covers the light source module 1, is provided on the heat sink 3. FIG. 8 is a schematic cross sectional view of the cover 5 of the lighting apparatus 100 related to the present embodiment. The cover 5 is made of milky-white glass having the shape of a hemispherical enclosure. The cover 5 includes a light-permeable portion 51 having the shape of a hemispherical enclosure and an attaching portion 52 connected to an opening of the light-permeable portion 51. As shown in FIG. 8, the attaching portion 52 having the cylindrical shape of which the diameter continually decreases from the side of the light-permeable portion 51 to the other side. With regard to the attaching portion 52, for making an opening end portion 53 as the end portion of the cover 5 freely fit to the groove 34 of the heat sink 3, the diameter of a partial inner surface 52a, which is freely fitted to the groove 34, is formed to be slightly longer than that of the outer circumferential surface 33b of the inner peripheral wall 33 vertically arranged on the flange part 36 of the heat sink 3, and the diameter of a partial outer surface 52b, which is freely fitted to the groove 34, is formed to be slightly shorter than that of the inner circumferential surface 35a of the outer peripheral wall 35 vertically arranged on the flange part 36 of the heat sink 3. The cover 5 is attached to the heat sink 3 as stated below.

First, an adhesive agent 55 is applied in the groove 34 of the heat sink 3. For example, a silicon-system adhesive agent is used as the adhesive agent 55. The adhesive agent 55 is applied over the entire circumference in the circumferential direction except the appropriate span (for example, 7 mm) including the position where the slit 35c of the groove 34 is provided. Next, the cover 5 is freely fitted to the groove 34 from the opening end portion 53 and pressed towards the heat sink 3 with a predetermined force. The adhesive agent 55 is solidified, so that the cover 5 is adhered and fixed to the heat sink 3. In the fixing state, the adhesive agent 55 is applied with a gap formed on at least one part between the groove 34 of the heat sink 3 and the opening end portion 53 of the cover 5 as shown in FIG. 5. Therefore, a gap is created corresponding to the thickness of the adhesive agent 55 to be applied between the opening end portion 53 of the cover 5 and the groove 34 of the heat sink 3.

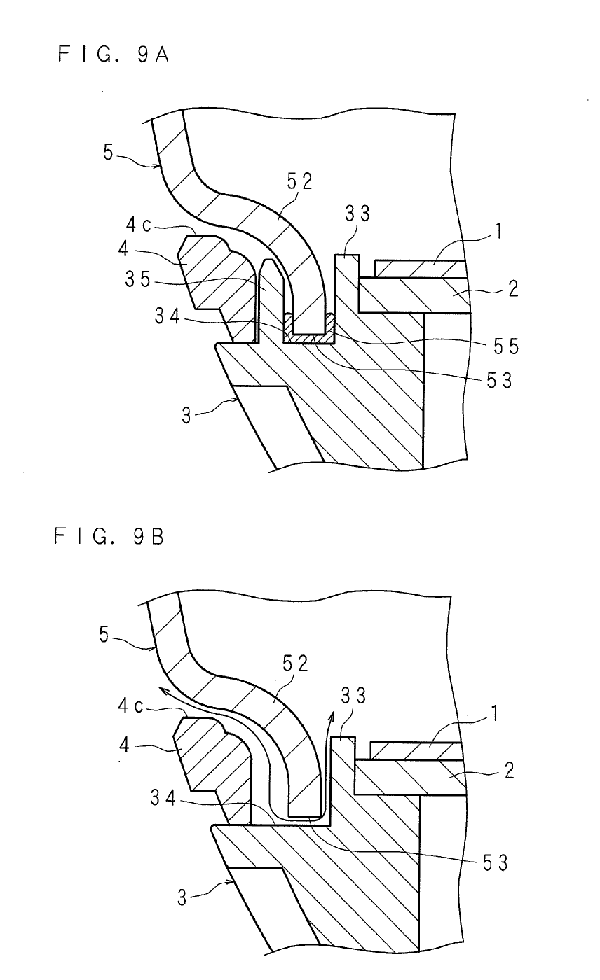

FIGS. 9A and 9B are schematic local enlarged cross sectional views of an essential part of the lighting apparatus related to the present embodiment, these figures are also explanatory drawings illustrating the cover 5 being adhered to the heat sink 3. FIG. 9A is a local sectional view of the lighting apparatus 100 illustrating the vicinity of the opening end portion 53 of the cover 5 at the part where the adhesive agent 55 is applied. FIG. 9B is a local sectional view of the lighting apparatus 100 illustrating the vicinity of the opening end portion 53 of the cover 5 at the slit 35c part where the adhesive agent 55 is not applied. In the part where the adhesive agent 55 is applied (as referring to the most part where the cover 5 is freely fitted to the groove 34), the adhesive agent 55 is filled between the opening end portion 53 of the cover 5 and the groove 34 as shown in FIG. 9A.

On the other hand, in the part where the adhesive agent 55 is not applied, the distance between the outer circumferential surface 33b of the inner peripheral wall 33 and the inner circumferential surface 35a of the outer peripheral wall 35 is formed to be larger than the thickness of the opening end portion 53 of the cover 5, and a gap is formed between the inner peripheral wall 33 and outer peripheral wall 35 as sidewalls of the groove 34 and the opening end portion 53. Additionally, a gap is created corresponding to the thickness of the adhesive agent 55 applied to the other parts of the groove 34 between the bottom surface of the groove 34 and the opening end portion 53. Therefore, a gap is formed between the opening end portion 53 of the cover 5 and the groove 34 as shown in FIG. 9B. Since the adhesive agent 55 illustrated in FIG. 9A is not filled also in the part where the adhesive agent 55 is applied as referring to the part other than the slit 35c, a gap is formed between the opening end portion 53 of the cover 5 and the groove 34.

As a result, it is possible to communicate between inside and outside of the lighting apparatus 100 as indicated by the arrow in FIG. 9B. The thickness and range of the applied adhesive agent 55 is appropriately determined in order to obtain a necessary cross sectional area of the communication opening for communicating between inside and outside of the lighting apparatus 100 in other words necessary cross sectional area of air flow. In the state of the groove 34 of the heat sink 3 not being entirely applied by the adhesive agent 55, it is preferable to form a suitable gap between the attaching portion 52 of the cover 5 and both of the inner peripheral wall 33 and the outer peripheral wall 35 as sidewalls of the groove 34 of the heat sink 3 and the covering 4 when the cover 5 is inserted into the groove 34 of the heat sink 3 and the opening end portion 53 of the cover 5 is in contact with the bottom surface of the groove 34. As a result, it is possible to appropriately determine the amount of air, which is communicated between inside and outside of the cover 5, corresponding to the thickness of the adhesive agent 55.

A base 7 is provided through a connecting body 6 on the opposite side of the flange part 36 of the tube 31 of the heat sink 3. The connecting body 6 has a closed end cylindrical shape and includes a base holder 61 holding the base 7 and a heat sink holder 62 connected to the base holder 61 and holding the heat sink 3. The base holder 61 has an aperture for an electric wire at the bottom. The outer circumferential surface of the base holder 61 is threaded for screwing with the base 7. Both of the base holder 61 and the heat sink holder 62 are made of, for example, electric insulating materials such as resin and the like, and are formed in an integrated manner. The connecting body 6 is integrated with the heat sink 3 by fixing with screw in the state that threaded hole at the side of the heat sink holder 62 aligns with the coupler 30 of the heat sink 3. For preventing from moisture and the like running into the interior section, a packing 60 made of resin is interposed between the coupler 37 of the heat sink 3 and the heat sink holder 62 of the connecting body 6.

The base 7 has a closed end cylindrical shape and includes a one-pole terminal 71 of which the cylindrical portion is threaded for screwing with a light-bulb socket and an opposite-pole terminal 72 protruded at the bottom of the base 7. These terminals 71 and 72 are insulated. The outline shape of the cylindrical portion of the base 7 is formed to be similar to the shape of E26 threaded base as an example. The base holder 61 of the connecting body 6 is inserted and screwed with the base 7, so that the base 7 is integrated with the connecting body 6.

The cavity, which is formed by the integration of the heat exchanger plate 2, the heat sink 3, the connecting body 6 and the base 7, houses a power supply section 8 providing a power of predetermined voltage and current to the light source module 1 through an electric wire, a holder 9 holding the power supply section 8 in the cavity, and the like.

The power supply section 8 includes a rectangular power supply circuit substrate 81 and a plurality of circuit components 82 mounted on the power supply circuit substrate 81. The holder 9, which holds the power supply section 8, is made of electric insulating materials such as resin and the like. The holder 9 has the shape wherein the holder 9 can be inserted into the tube 31 of the heat sink 3 so as to cover the inner circumferential surface of the tube 31. Additionally, a ring-shaped holding ring 86 is interposed between the power supply section 8 and the heat exchanger plate 2 in order to separate the power supply circuit substrate 81 from the heat exchanger plate 2 at an appropriate distance. The holding ring 86 is made of, for example, electric insulating materials such as resin and the like. Additionally, an insulating sheet 87 is attached to the other surface 2b of the heat exchanger plate 2. It is electrically insulated between the power supply section 8 and both of the heat exchanger plate 2 and the heat sink 3 due to the connecting body 6, the holder 9, the holding ring 86 and the insulating sheet 87.

The power supply section 8 is electrically connected through an electric wire (not shown) to both of the one-pole terminal 71 and the opposite-pole terminal 72 of the base 7. Additionally, the power supply section 8 is electrically connected through an electric wire (not shown) to the light source module 1 by a connector. A pin plug may also be used for making electrical connection instead of using an electrical wire.

The lighting apparatus 100, which is configured as described above, is connected to an external AC power source by screwing the base 7 with the light-bulb socket. When the power source is on, AC current is supplied to the power supply section 8 though the base 7. The power of predetermined voltage and current is supplied to the light source module 1 by the power supply section 8 and then the LED 12 lights up.

With regard to the lighting apparatus 100 configured as above, since the cover 5 is adhered to the heat sink 3 by applying the adhesive agent with a gap formed between the cover 5 and the heat sink 3, it can be communicated between inside and outside of the lighting apparatus 100 through the gap. Therefore, the temperature difference and the pressure difference between the inside and outside of the lighting apparatus 100 can be suppressed so that the occurrence of defects due to condensation and the like can be prevented.

In the lighting apparatus 100 related to the present embodiment, the groove 34, to which the opening end portion 53 of the cover 5 is freely fitted, is provided on the heat sink 3. The adhesive agent 55 is applied with a gap formed between the groove 34 and the opening end portion 53 of the cover 5 as described above, and the cover 5 is adhered to the heat sink 3. In the part where the adhesive agent 55 is not applied, the distance between the outer circumferential surface 33b of the inner peripheral wall 33 and the inner circumferential surface 35a of the outer peripheral wall 35 is larger than the thickness of the opening end portion 53 of the cover 5. Therefore, a gap is formed between both of the inner peripheral wall 33 and the outer peripheral wall 35 as the sidewalls of the groove 34 and the opening end portion 53. Also, a gap is created corresponding to the thickness of the adhesive agent 55 applied to other portions of the groove 34 between the bottom surface of the groove 34 and the opening edge portion 53. As a result, a gap is formed between the opening end portion 53 of the cover 5 and the groove 34 of the heat sink 3, therefore, it can be firmly communicated between inside and outside of the lighting apparatus 100. Thus, the temperature difference and the pressure difference between the internal air and external air of the lighting apparatus can be suppressed so that the occurrence of defects due to condensation and the like can be firmly prevented.

Moreover, the slit 35c is provided at the outer peripheral wall 35 as the sidewall of the groove 34 for communication between inside and outside of the lighting apparatus 100. Therefore, the internal and external air of the lighting apparatus 100 can be easily circulated so as to suppress the temperature difference and the pressure difference. Therefore, the occurrence of defects due to condensation and the like can be more firmly prevented.

As comparing to the case that the adhesive agent is applied across the entire circumference of the groove 34, the amount of the adhesive agent to be used can be reduced.

In the present embodiment, the adhesive agent 55 applied in four ranges of the groove 34 of the heat sink 3 with same intervals in the circumferential direction. However, the range of adhesive agent to be applied is not limited. The adhesive agent may also be applied with a gap on at least one part between the groove 34 and the opening end portion 53 of the cover 5.

The slit 35c is provided at a location corresponding to the discontinuity part of the adhesive agent 55, however, the location may be formed as one part of the communication opening. Additionally, the slit 35c is provided at the outer peripheral wall 35, however, the slit may be provided at the inner peripheral wall 33 as well as the outer peripheral wall 35. The shape of the slit is not limited in the present embodiment, and the number of slits is not limited to 4. Moreover, in the present embodiment, the slit also functions as the concave portion for alignment of the covering 4. It is needless to say that the slit may be used for other purposes.

The cover 5 is not limited to the shape of a hemispherical enclosure. The cover 5 may have a shape corresponding to the lighting apparatus wherein the cover for covering a light source is attached through adhesion. Additionally, in the present embodiment, the cover is made of milky white glass, however, the cover may also be made of transparent glass or resin.

With regard to the embodiments described above, a surface-mount LED is utilized as the light source, however, other different types of LED and EL (Electro Luminescence) may also be utilized as the light source.

With regard to the embodiments described above, a light-bulb type lighting apparatus attached to a light-bulb socket is described, however, other types of lighting apparatuses may also be applicable. Besides, it is needless to say that the scope of matter described in claims can be practiced by other modified modes.

### Description of Reference Signs

1 Light Source Module (Light Source)
3 Heat Sink (Holder)
34 Groove
35 Outer Peripheral Wall (Sidewall)
35c Slit
5 Cover
53 Opening End Portion (End Portion)
55 Adhesive Agent

1-3. (canceled)

4. A lighting apparatus comprising:
a light source;
a holder holding the light source; and
a light-permeable cover mounted to the holder and covering the light source,
wherein the cover is adhered to the holder by an adhesive agent applied with a gap formed on at least one part between the cover and the holder.

5. The lighting apparatus according to claim 4,
wherein a groove to which an end portion of the cover is freely fitted is provided on the holder, and
wherein the adhesive agent is applied with a gap formed on at least one part between the groove and the end portion of the cover.

6. The lighting apparatus according to claim 5,
wherein a slit communicating between inside and outside of the lighting apparatus is provided at a sidewall of the groove.

7. The lighting apparatus according to claim 6,
wherein the slit is provided on the location corresponding to the part where the adhesive agent is not applied.

8. The lighting apparatus according to claim 6, further comprising
a covering having a protrusion,
wherein the position of the covering is determined by fitting the protrusion to the slit and then the covering is attached to the holder.

9. The lighting apparatus according to claim 5,
wherein the groove is a ring-shaped groove having an inner peripheral wall and an outer peripheral wall provided concentric with the holder, as sidewalls.

10. The lighting apparatus according to claim 4,
wherein the holder is a heat sink radiating heat from the light source.
